(19) United States
(12) Patent Application Publication
(10) Pub. No.: US 2005/0259008 A1
(43) Pub. Date: Nov. 24, 2005

(54) Broadband array antennas using complementary antenna

(75) Inventor: Mats Gustafsson, Malmo (SE)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson (publ), Stockholm (SE)

(21) Appl. No.: 11/099,520

(22) Filed: Apr. 6, 2005

Related U.S. Application Data
(60) Provisional application No. 60/572,774, filed on May 21, 2004.

(51) Int. Cl. H01Q 1/38

(52) U.S. Cl. 343/700 MS; 343/846

(57) ABSTRACT

A wide band antenna array comprising patch elements and a ground plane, in which the array constitutes an infinite self-complimentary structure providing large bandwidth and utilizes dielectric slabs above the antenna elements. The dielectric slabs will match the impedance of the antenna elements to free space.

### FIELD OF THE INVENTION

The present invention relates to antennas using a self-complementary antenna structure and more particularly using a few dielectric slabs for obtaining a broadband array antenna.

### BACKGROUND

Self-complementary antennas are basic prototypes of frequency independent antennas. They exist both as single antenna elements and antenna arrays. It is well known that planar self-complementary antennas have a constant impedance of Z₀/2=188.5 Ω, i.e., half the intrinsic impedance of space. Since the planar self-complementary antenna array radiates both up and down, i.e., bidirectional, the effect of inserting a backing ground plane is devastating [1]. The effects of the ground plane can be reduced by radar absorbing material between the antenna elements and the ground plane. This gives a broadband array at the expense of half the power is absorbed in the radar absorbing material. In this paper, it is shown that stacking of dielectric slabs above planar self-complementary antenna elements can reduce the degrading effect of the ground plane and hence be used to design ultra-wideband antennas. The dielectric slabs act as filters and transform the impedance seen by the antenna elements. The slabs are chosen to be of equal optical thickness, and, hence, resembling the use of quarter-wave length transformers in broadband matching [2]. Numerical results are presented for the infinite antenna array with broadside bandwidths of 4.7:1 at −13 dB and of 5.5:1 at −17 dB for the cases of two and three dielectric slabs, respectively.

The use of dielectric slabs to improve antenna performance is not new. A dielectric slab can be used for wide-angle impedance matching of planar arrays as shown in [3]. In [2], it has also been shown that dielectric slabs can be used to improve the bandwidth of an array composed of closely spaced dipoles.

### SUMMARY OF THE INVENTION

A thin dielectric slab (‘dielectric under-ware’) is used as an environmental protection of the patch array. It is observed that the thin dielectric slab hardly changes the impedance at all. Due to the constant impedance character of the complementary array, the effect of a ground plane is profound. The effect of changing the ground-plane distance is mainly a rotation and stretching of the impedance in the Smith chart, i.e., a frequency scaling. A wide band antenna array comprising patch elements and a ground plane, in which the array constitutes an infinite self-complimentary structure providing large bandwidth and utilizes dielectric slabs above the antenna elements whereby the dielectric slabs will match the impedance of the antenna elements to free space. In a typical embodiment at least three slabs are used, whereby each slab adds a loop to the input impedance as can be seen visualized in a Smith chart.

### SHORT DESCRIPTION OF THE DRAWINGS

The invention, together with further objects and advantages thereof, may best be understood by making reference to the following description taken together with the accompanying drawings, in which:

FIG. 1a illustrates the array geometry in a top view where thr infinite array consists of a periodic repetition of square perfectly electric conductor (PEC) patches at the corners;

FIG. 1b illustrates a side view where dielectric slabs with optical thickness d are stacked above the patches;

FIG. 2 generally illustrates simulated impedance at broadside scan with frequencies given in GHz;

FIG. 2a the patch array as the dot in the centre, patch array together with the environmental protection as the short arc leaving the centre, the ground plane transforms impedance to rotate around Z₀/2;

FIG. 2b with impedance normalized to 175 Ω for the single dielectric slab with ε₁=4 giving a −10 dB bandwidth of 4:1;

FIG. 2c with impedance normalized to 120 Ω for the two dielectric slabs case with d=8 mm, ε₁=7 and ε₂=3 giving a −13 dB bandwidth of 4.7:1;

FIG. 2d with impedance normalized to 120 Ω for the three dielectric slabs case with d=8 mm, ε₁=7.2 and ε₂=3.4 and ε₃=1.8 giving a −17 dB bandwidth of 5.5:1;

FIG. 3a illustrates simulated reflection coefficients normalized to 120 Ω for the two slab case for the scan angles of 30°, 45°, and 60° for H-plane;

FIG. 3b illustrates simulated reflection coefficients normalized to 120 Ω for the two slab case for the scan angles of 30°, 45°, and 60° for E-plane;

FIG. 4a illustrates simulated reflection coefficients normalized to 120 Ω for the three slab case for the scan angles of 30°, 45°, and 60° for H-plane;

FIG. 4b illustrates simulated reflection coefficients normalized to 120 Ω for the three slab case for the scan angles of 30°, 45°, and 60° for E-plane;

FIG. 5a illustrates a parametric study of the patch with two dielectric slabs when impedance is simulated and normalized to 120 Ω and variation of the patch width for a fixed ground plane distance d=10 mm and fixed dielectric slabs;

FIG. 5b illustrates a parametric study of the patch with two dielectric slabs when impedance is simulated and normalized to 120 Ω and variation of the ground plane distance d and slab thickness for fixed patch width of a=4.8 mm.

### DETAILED DESCRIPTION OF THE INVENTION

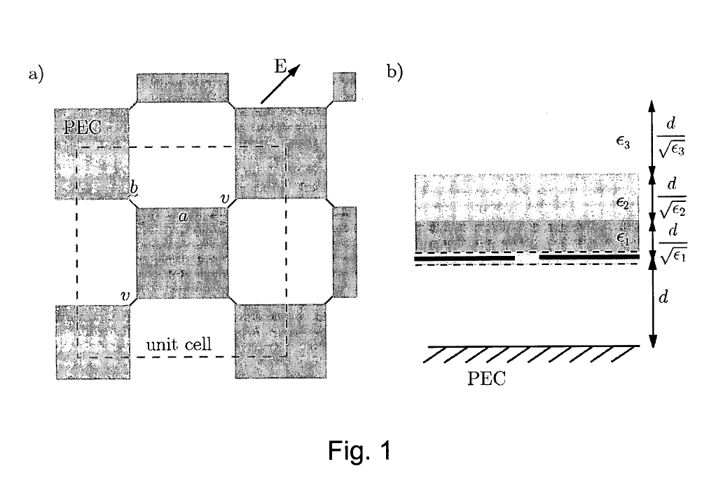

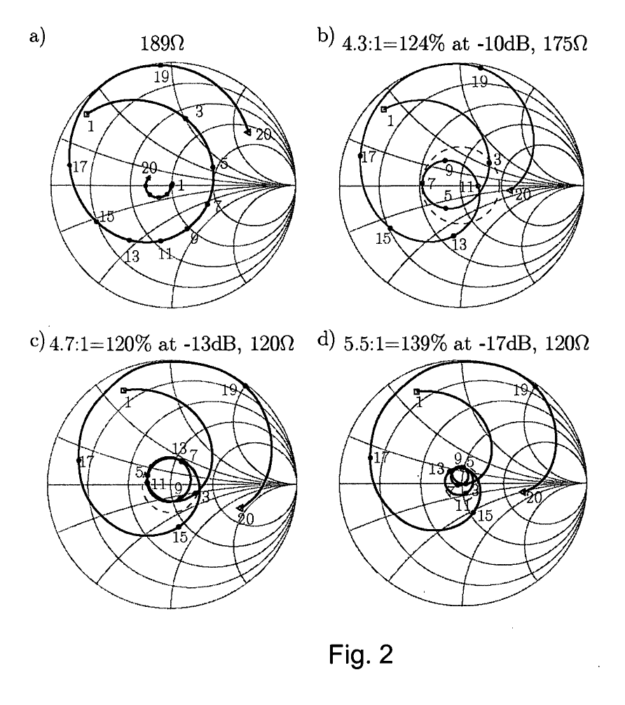

In this paper, we consider an infinite antenna array consisting of PEC patches as depicted in FIG. 1. The patches are fed at the corners of each patch [4] giving a linear polarized field in the ±45° directions depending on the used feed points. The patch array is almost self complementary, i.e., the PEC structure is almost identical to its complement. Due to the self-complementary structure, it is reasonable to assume that the characteristic of the patch does not depend strongly on the dimensions of the patch. To start, the width of the patches a=3.6 mm and the feed point distance b=0.3 mm are used, see FIG. 1a. The infinite antenna array can be simulated with either the FDTD, MoM, or FEM as long as the code can handle periodic boundary conditions [2], [5]. Here, the code periodic boundary FDTD (PB-FDTD) developed by H. Holter [5] is used. Numerical simulations, using PBFDTD, verify that the impedance is frequency independent and equal to Z₀=2. The input impedance normalized to 189 Ω for the frequency range 1 GHz to 20 GHz is seen as the dot in the centre of the Smith chart in FIG. 2a.

A thin dielectric slab (‘dielectric under-ware’ [2]) is used as an environmental protection of the patch array. From the results in FIG. 2a, it is observed that the thin dielectric slab (1 mm with ε=2.33) hardly changes the impedance at all. The effect is seen as the small arc going from the centre in the Smith chart. Due to the constant impedance character of the complementary array, the effect of a ground plane, here at the distance d=8 mm, is profound as seen in FIG. 2a. The impedance grazes the rim of the Smith chart at approximately 18 GHz, corresponding to the destructive interference of a ground plane distance of half a wavelength [1]. The effect of changing the ground-plane distance is mainly a rotation and stretching of the impedance in the Smith chart, i.e., a frequency scaling.

We now consider the patch array together with its environmental protection as fixed and improve the bandwidth by placing dielectric slabs above the elements. The transformation properties of the thin slab are minimal [2]. The dielectric slabs act as a filter matching the antenna for a range of frequencies f₁•f•fᵤ. The upper frequency fᵤ is limited by the onset of grating lobes and the destructive interference from a ground plane at half a wavelength distance. In analogy with quarter-wave transformers in broadband matching, the ground plane distance and the slabs are chosen to be of equal optical thickness, i.e., a slab thickness of d/√εᵢ is used [2]. The case with a single dielectric slab is easily analyzed with a parametric study. The result with a single dielectric slab is seen in FIG. 2b. In this case the dielectric slab can be designed to give one single loop in the centre of the Smith chart. The −10 dB bandwidth of approximately 4:1 is comparable to the case of wire dipoles above a ground plane without dielectric slabs [2].

It is reasonable that the bandwidth can be improved by stacking more dielectric slabs above the patch array. As the number of slabs increases, the parametric study gets more involved. The effect of stacking several dielectric slabs above the patch array can be analyzed with a global optimization algorithm, e.g., the Genetic Algorithm [6]. However, empirical studies have showed that the permittivities can be chosen from a parametric study of a set of slabs generated by a constant reflection coefficient between two slabs, i.e., εᵢ=εᵢ₊₁(1+ρ)²/(1−ρ)² for i=1, . . . , N where N is the number of slabs (here N=2 or N=3) and ε_{N+1}=1. The parametric study (or line search) in ρ gives good initial values of the permittivities. These values are easily improved by the use of a parametric study.

The −10 dB bandwidth increases to 5.8:1 and 7.1:1 for two and three dielectric slabs, respectively. The loops are centred in the Smith chart with a normalization of 120 Ωas seen in FIGS. 2c and 2d. As seen in FIG. 2c, the impedance makes two overlaying loops in the Smith chart with two slabs. The third slab adds a loop and hence increases the bandwidth and tightens the impedance to the centre of the Smith chart. The property of adding loops in the centre of the Smith chart is very favourable as it gives an almost constant magnitude of the reflection coefficient over the matched frequency range. In the sense of Fano theory, this is an optimal behaviour. The Fano theory is based on the analytical properties of lossless matching networks and can be used to obtain fundamental limitations on the bandwidth. It states that bandwidth is sacrificed by a perfect match at a discrete set of frequencies [7]. It is also interesting to observe that the property of adding loops in the Smith chart is similar to the result of Chebyshev transformers where each quarter-wave transformer adds an approximate loop in the Smith chart.

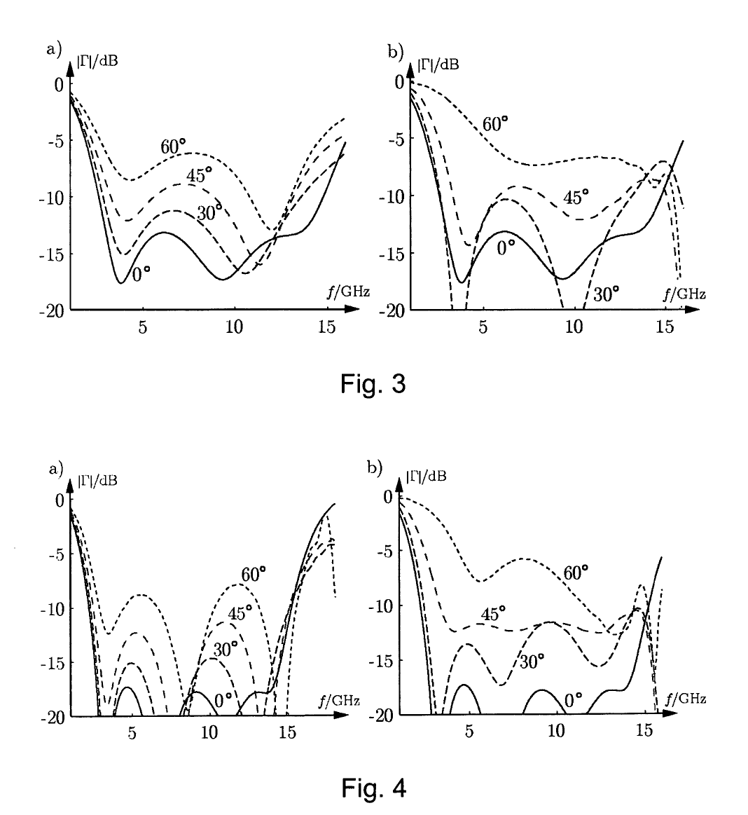

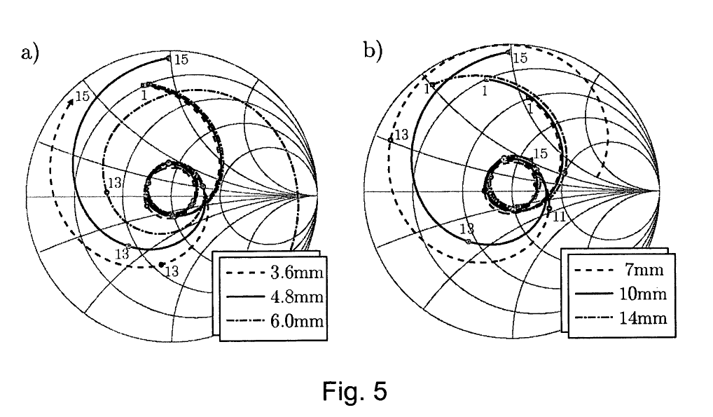

The magnitude of the reflection coefficient ═⊕═ is used to illustrate the behaviour versus the scan angle. The effects of increasing scan angles are shown in FIG. 3 for the two slab case. The scan angles 30°, 45°, and 60° are considered in both the H-plane and E-plane, where the H-plane and E-plane are the ±45° diagonal planes, see FIG. 1. As seen in FIG. 3, the reflection coefficient increases with increasing scan angle as expected. This corresponds to input impedance loops with an increased radius in the Smith chart. Hence, the bandwidth reduces as the scan angle increases. The −10 dB bandwidth is only slightly reduced for scan angles up to 30°. However, as the scan angle increases beyond 45°, there is a range of frequencies at the centre frequencies that is not matched. The corresponding results for three dielectric slabs are shown in FIG. 4. Here, it is seen that the range of scan angles increases up to approximately 45°. As the impedance of a self-complementary structure is independent of the geometry of the structure it is reasonable that the input impedance of the patch array does not depend strongly on the dimensions of the patch elements. In FIG. 5a, the input impedance, normalized to 120 Ω, of the two slab case is shown for the patch widths 3.6 mm, 4.8 mm, and 6.0 mm. The ground plane distance is 10 mm and the slab parameters are as in FIG. 2c. As seen in FIG. 5a, the input impedance is almost independent of the patch width up to 12 GHz. For higher frequencies the input impedance start to differ as the distance between two feed points approach half a wavelength and hence the onset of grating lobes. The onset of grating lobes at 15 GHz corresponds to a patch width of just above 6 mm. The frequency independent property of the patch array can also be seen in FIG. 5b, where the vertical dimensioning is changed, i.e., the ground plane distance is changed from 7 mm to 14 mm. In other words the patch elements will not be resonant, but the working bandwidth is defined by the distance to the ground plane and

### CONCLUSIONS

In this paper it has been shown that infinite self-complementary antenna arrays above a ground plane together with dielectric slabs above the antenna elements can be used to design broadband antennas. The dielectric slabs match the impedance of the antenna elements to free space. It is shown that, at least for the three first slabs, each slab adds one loop to the input impedance in the Smith chart. Moreover, the radius of the loops reduces with increasing number of slabs, and hence reducing the reflection coefficient over a large bandwidth. It is interesting to observe that the circular loop pattern gives an almost constant reflection factor over the matched frequencies. The presented results based on an infinite antenna and a simple feed model indicates that dielectric slabs are useful in the design of broadband arrays based on self-complementary structures. When realizing as antenna design it is of course necessary to improve the model of the feeding network, analyze finite arrays, and obtain experimental verification. It is interesting to compare the performance of the self-complementary array presented here with results for arrays composed of closely spaced wire dipoles presented in [2]. In free space, the dipole array is broad band but not frequency independent as the self-complementary array. This is utilized in the dipole case by carefully balancing the reactive effects between the dipoles and the ground plane, and hence increasing the bandwidth [2].

1. wide band antenna array comprising patch elements and a ground plane, wherein said array constitutes an infinite self-complimentary structure providing large bandwidth by utilizing dielectric slabs above the antenna elements whereby said dielectric slabs match the impedance of the antenna elements to free space.

2. The array according to claim 1, wherein at least three slabs are used, whereby each slab adds a loop to the input impedance as seen visualized in a Smith chart.

3. The array according to claim 2, wherein radius of each such loop reduces with an increasing number of slabs, and hence reducing reflection coefficient over a large bandwidth.

4. The array according to claim 3, wherein an almost constant reflection factor is obtained over matched frequencies and is visualized by such a circular loop pattern in said Smith chart.

5. The array according to claim 4, wherein the antenna elements or patches are non-resonant.

6. The array according to claim 1, wherein the working bandwidth primarily will be dependent of the distance to the ground plane and the thickness of the dielectric slab, and will be highly independent of the size of antenna patch elements.
